(19) United States
(12) Patent Application Publication
(10) Pub. No.: US 2020/0198058 A1
(43) Pub. Date: Jun. 25, 2020

(54) MOLD COMPONENT MANUFACTURING METHOD AND MOLD COMPONENT

(71) Applicant: SUMITOMO ELECTRIC SINTERED ALLOY, LTD., Takahashi-shi, Okayama (JP)

(72) Inventor: Takanori OOTAKI, Takahashi-shi, Okayama (JP)

(73) Assignee: SUMITOMO ELECTRIC SINTERED ALLOY, LTD., Takahashi-shi, Okayama (JP)

(21) Appl. No.: 16/620,072

(22) PCT Filed: Jun. 6, 2018
(86) PCT No.: PCT/JP2018/021779

§ 371 Date: Dec. 6, 2019

(30) Foreign Application Priority Data
Jun. 7, 2017 (JP) 2017-112899

(51) Int. Cl. B23K 26/342; B22F 3/105; B21C 25/02

(52) U.S. Cl. CPC B23K 26/342; B22F 3/105; B22F 2003/248; B22F 2202/11; B21C 25/02

(57) ABSTRACT

A mold component manufacturing method that includes a step of forming a first surface by removing a predetermined region that contains a worn location from a worn mold component, and a step of building up a steel material on the first surface.

### TECHNICAL FIELD

The present invention relates to a mold component manufacturing method, and a mold component.

The present application claims priority based on Japanese Patent Application No. 2017-112899 filed on Jun. 7, 2017, the disclosure of which is hereby incorporated in its entirety by reference.

### BACKGROUND ART

Conventionally, when a raw material powder is press-compacted to manufacture a compact, a powder metallurgy mold (which may be simply referred to as a “mold” hereinafter) provided with a mold component such as a punch or a die is used, and the raw material powder is put into the mold and is pressed and compacted with use of a press. The compact may be used as a manufactured product without further processing, or may be sintered to obtain a sintered component. In general, steel with high hardness and superior wear-resistance is often used for a mold base material, and a tool steel such as high-speed steel may be used, for example (see Patent Documents 1 and 2).

### CITATION LIST

### Patent Documents

Patent Document 1: JP 2009-12039A

Patent Document 2: JP 2009-120918A

### SUMMARY OF INVENTION

A mold component manufacturing method according to the present disclosure includes:

a step of forming a first surface by removing a predetermined region that contains a worn location from a worn mold component; and

a step of building-up the first surface with a steel material.

A mold component according to the present disclosure includes:

a base material that includes a first surface; and

a built-up portion formed on the first surface of the base material, wherein

the built-up portion has a laminate structure in which a plurality of layers formed from a steel material are stacked.

### BRIEF DESCRIPTION OF DRAWINGS

FIG. 1 is a schematic longitudinal sectional view showing an example of a punch on which a built-up portion is formed.

FIG. 2 is a diagram schematically showing a cross-section of a mold component according to an embodiment.

### DESCRIPTION OF EMBODIMENTS

### Problem to be Solved by the Present Disclosure

It is desirable to recycle and reuse a worn mold component.

Steels with high levels of hardness have poor machinability and are not easy to cut. For this reason, if a tool steel such as high-speed steel or the like is used for a mold component base material, the mold component is usually manufactured by rough processing the tool steel in an annealed state, then thermally processing (quenching and tempering) and refining the tool steel to a hardness of about 60 HRC, and thereafter performing finishing processing thereon.

The mold surface of a mold component of a powder metallurgy mold will become worn and droop when used for repeated press-compacting. If the mold component becomes worn, burrs may form on the compact, which may lead to a lower level of dimensional accuracy or a degradation of the surface properties of the compact. If drooping occurs in the mold component, the worn portion is removed, the surface that is exposed due to said removal is reworked and repaired into a mold surface, and thus the mold component can be reused. However, if the wear of the mold component reaches the limit of usability, there is no room for removal and repair is no longer possible, and thus the worn mold component is disposed of and is replaced with a new mold component. In this case, it is necessary to manufacture a completely new mold component, but manufacturing a completely new mold component incurs large costs and takes time.

Thus, an objective is to provide a mold component manufacturing method for recycling a worn mold component. Also, another objective is to provide a recycled mold component.

### Advantageous Effects of the Present Disclosure

With the mold component recycling method and the mold component according to the present disclosure, it is possible to reduce the cost and time needed to manufacture a mold by recycling a worn mold component.

### Description of Embodiments of the Present Disclosure

First, an embodiment of the present embodiment will be described.

(1) A mold component manufacturing method according to an embodiment of the present invention includes:

a step of forming a first surface by removing a predetermined region that contains a worn location from a worn mold component; and

a step of building up a steel material on the first surface.

With the above-described mold component manufacturing method, a first surface is formed on a worn mold component by removing the region containing the worn location thereof, a steel material is built up on the first surface, the region that was removed is thereby built up, thus making it possible to improve the state-of-wear of the mold component. Thus, by recycling a worn mold component to the initial state thereof, or a state that is not the initial state thereof but is a state in which the mold component can be used, it is possible to reduce the cost and time needed to manufacture a mold compared to making a completely new mold component.

(2) In another mode of the mold component manufacturing method described above, a maximum height Rz of surface roughness of the first surface is less than or equal to 1 μm.

In the step of removing the region of the mold component that contains the worn location to form the first surface, the first surface is formed with a maximum height Rz of 1 μm or less and the first surface is a flat surface, and thus it is easy to form the built-up portion. “Maximum height Rz” is a value measured according to JIS B 0601-2001. When measuring the maximum height Rz, the standard length is 0.1 mm and the evaluation length of 2.0 mm.

(3) In another mode of the mold component manufacturing method described above, in the building-up step, a built-up portion is formed by sequentially forming a layer of a powder of the steel material on the first surface and irradiating the powder with a laser.

By forming layers of the steel material powder on the first surface, melting the powder with a laser, and solidifying the melted powder to create a built-up portion, it is easy to form a built-up portion with a uniform thickness on the region removed from the mold component.

(4) In another mode of the mold component manufacturing method described above, the Vickers hardness of the built-up portion formed through the building-up step is at least 90% as hard as the Vickers hardness of a base material of the mold component.

By making the Vickers hardness of the built-up portion to be at least 90% as hard as the Vickers hardness of the base material of the mold component, the built-up portion is harder than, or has a similar level of hardness to, the base material of the mold component and therefore it is possible to ensure deformation resistance and wear resistance that are by no means inferior to that of a mold component in the initial state thereof (a new mold component).

(5) In another mode of the mold component manufacturing method described above, the steel material is a quenched and tempered steel and, after the building-up step, a step is provided in which the mold component that has been built up is tempered.

In the building-up step, the steel material is melted and solidified to form the built-up portion. When quenched and tempered steel is built up, the melted steel quickly solidifies and thus the built-up portion has a structure that is close to that of a quenched state. In a quenched state, the built-up portion may be brittle with insufficient toughness, and therefore it is possible to increase the toughness and improve the fracture resistance of the built-up portion through tempering. In particular, if the type of steel used for the base material of the mold component is a quenched and tempered steel similar to that of the built-up portion, then it is possible to make the structure of the built-up portion substantially the same as the structure of the base material by tempering the mold component that has the built-up portion formed thereon. This is preferable as it makes it possible to homogenize the mechanical properties of the entire mold component.

(6) In another mode of the mold component manufacturing method described above, the mold component is a punch.

The above-described mold component manufacturing method can be suitably used to recycle a worn punch.

(7) A mold component according to a mode of the present invention includes:

a base material that includes a first surface; and

a built-up portion formed on the first surface of the base material, wherein

the built-up portion has a laminate structure in which a plurality of layers formed from a steel material are stacked.

The above-described mold component includes the built-up portion on the first surface of the base material. With the above-described mold component, it is possible to improve the state-of-wear of the mold component with use of the built-up portion, and it is possible to reduce the cost and time needed to manufacture a mold compared to making a completely new mold component.

### Detailed Description of the Embodiments of the Present Disclosure

The following describes a specific example of mold component manufacturing method and a mold component according to an embodiment of the present invention. The present invention is defined by the terms of the claims, but not limited to the above description, and is intended to include any modifications within the meaning and scope equivalent to the terms of the claims.

### Mold Component Manufacturing Method

The mold component manufacturing method according to the embodiment includes a preprocessing step of removing a predetermined region from a worn mold component to form a first surface, and a building-up step of building up the steel by building-up steel on the first surface. One feature of the mold component manufacturing method according to the embodiment is that the mold component is restored to the initial state thereof before being worn, or to a state close to the initial state thereof before being worn, by building-up steel on the first surface that is formed on the worn mold component. The following is a detailed description of the steps.

### Preprocessing Step

The preprocessing step is a step of forming the first surface by removing a predetermined region that includes the worn location from a worn mold component.

The mold component of the present example is a component of a powder metallurgy mold that is used for press-compacting a raw material powder, an example of which is a punch or a die. Steel is used for the base material of the mold component, and a tool steel such as high-speed steel, die steel, or the like is typically suitable for use. A metal powder such as iron, aluminum, or an alloy of either, a ceramic powder such as alumina, or the like are examples of the raw material powder to be press-compacted. A lubricant may also be added to the raw material powder with the aim of increasing lubricity during press-compacting. The compacting pressure during press-compacting may be, from the viewpoint of increasing the density of the compact that is press-compacted from the raw material powder, 500 MPa or more, or more preferably 600 MPa or more. If the base metal powder used for the raw material powder is pure iron powder or iron alloy powder, the density of the compact may be, for example, 6.5 g/cm³ or more, and 7.2 g/cm³ or less.

In the preprocessing step, if the mold component is a punch for example, a predetermined length of an end portion thereof that includes the worn mold surface is cut away, and the new end surface thus becomes the first surface. The first surface is the surface that will be built up a steel material on in the post-processing step, and it is therefore preferable that the first surface is a flat surface. The surface roughness of the first surface has a maximum height Rz of 1 μm or less, for example. The predetermined region of the metal component can be removed through machine processing, examples thereof including cutting (such as milling), wire cut electric discharge machining, and grinding (such as surface polishing).

### Building-Up Step

The building-up step is a step of forming a built-up portion by building-up steel on the first surface. Through this, the mold component is restored to the initial state thereof before being worn, or to a state close to that of the initial state thereof before being worn.

Building-up is a method in which steel is melted and then solidified to form the built-up portion, and thermal spraying, plasma powder building-up, laser powder building-up, or the like can be used. Methods of laser powder building-up include the so-called Powder Bed Fusion Method, in which a layer of steel powder is formed on a surface, irradiated and melted with a laser, and then solidified, and the so-called Laser Metal Deposition Method, in which a layer of metal powder is sprayed on a surface, irradiated and melted with a laser, and then solidified. Building-up with the Powder Bed Fusion Method can be implemented by using a 3D metal printer available on the open market (for example, the OPM250L manufactured by Sodick Co., Ltd.). If a method is used in which steel powder is layered for lamination while being melted with a laser, solidified, and built up, then it is easy to form a built-up portion with a uniform thickness. Also, in such a case, the steel powder is laid in layers, and the layers of powder are irradiated and melted with a laser and then solidified to form a layer. By repeating this to perform laminate molding, the obtained built-up portion is formed from steel and has a laminate structure in which a plurality of solidified layers are laminated.

The steel used for the built-up portion may be the same type as or different type from the base material of the mold component, and quenched and tempered steel, stainless steel, maraging steel, and the like, for example, can be used. Quenched and tempered steel includes tool steels such as high-speed steel or die steel.

In the building-up step, it is preferable that the Vickers hardness of the built-up portion is at least 90% as hard as the Vickers hardness of the base material of the mold component. In such a case, types of steel that have a level of hardness that is at least 90% as hard as the base material may be selected as a steel that can be used for the built-up portion. Thus, the built-up portion is harder than, or has a similar level of hardness to, the base material of the mold component and therefore it is possible to ensure deformation resistance and wear resistance that are by no means inferior to that of a mold component in the initial state thereof. It is more preferable that the Vickers hardness of the built-up portion is at least 95% as hard as the Vickers hardness of the base material. The upper limit of the Vickers hardness of the built-up portion is not particularly limited, but there is a tendency for the toughness of steel to degrade the higher the level of hardness is, and therefore the Vickers hardness of the built-up portion may be no more than 140% or more preferably no more than 120% as hard as the Vickers hardness of the base material, for example.

After the built-up portion is formed, finishing processing may be performed on the built-up portion and any dimensional irregularities of the built-up portion may also be corrected, as is necessary. The finishing processing may be machine processing, examples thereof including cutting (such as milling), wire cut electric discharge machining, and grinding (such as surface polishing).

### Tempering Step

If the steel used for the built-up portion is quenched and tempered steel, after the building-up step, a tempering step may also be included in which the mold component on which the built-up portion is formed undergoes tempering. If the built-up portion is formed from quenched and tempered steel, the built-up portion has a structure that is close to that of a quenched state, and therefore it is possible to increase the toughness and improve the defect resistance of the built-up portion through tempering. In particular, if the type of steel used for the base material of the mold component is quenched and tempered steel similar to that of the built-up portion, then it is possible, through tempering, to make the structure of the built-up portion substantially the same as the structure of the base material, and homogenize the mechanical properties of the entire mold component. In the case of tempering, finishing processing may also be performed on the built-up portion as necessary after tempering.

Mold Component

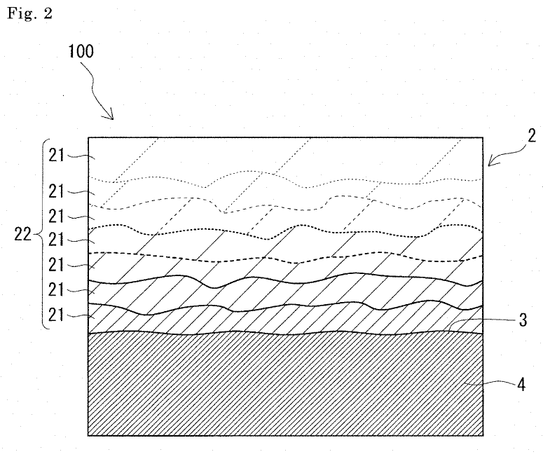

The following is a description of a mold component according to the embodiment with reference to FIG. 2. FIG. 2 shows a mold component 100 that includes a base material 4 having a first surface 3, and a built-up portion 2 that is formed on the first surface 3 of the base material 4. The built-up portion 2 has a laminate structure 22 in which a plurality of layers 21 formed from steel are stacked. The mold component 100 can be manufactured with the above-described mold component manufacturing method.

### Base Material

The base material 4 of the present example is steel. Preferably, before the built-up portion 2 is formed, the first surface 3 of the base material 4 is formed through surface grinding or the like to have a surface roughness (maximum height Rz) of 1 μm or less.

### Built-Up Portion

The built-up portion 2 is directly bonded to the first surface 3 of the base material 4. The built-up portion 2 of the present example is formed by repeatedly forming a layer of steel powder on the first surface 3 of the base material 4, irradiating and melting the layer of steel powder with a laser, solidifying the layer of irradiated and melted steel powder. In this case, the layers of melted and solidified steel powder are stacked on top of each other, thus forming the laminate structure 22 in which the plurality of layers 21 formed from steel are laminated, as shown in FIG. 2. The thickness of the layers 21 is dependent on the particle size of the powder of the steel that is used, which may be, for example, 10 μm or more and 100 μm or less, or more preferably 20 μm or more and 60 μm or less. The composition of the steel that is used to form the built-up portion 2 may be the same as the composition of the steel of the base material 4, or may be different.

If a powder of a steel of a different composition from that of the steel of the base material 4 is used to form the built-up portion 2, the built-up portion 2 will be formed with a composition that is different to that of the base material 4. Near the boundary with the base material 4 in the built-up portion 2, the composition will have a gradient due to the dispersion of the components of the base material 4. Specifically, the closer the layers 21 are to the first surface 3 of the base material 4 in the built-up portion 2, the more components of the base material 4 are contained therein and the more the built-up portion 2 becomes closer to the composition of the base material 4, and thus the difference in composition between the layers 21 becomes more significant. For this reason, as shown in FIG. 2, the closer the layers 21 are to the first surface 3 of the base material 4 in the built-up portion 2, the clearer the boundary between the layers 21 becomes due to the difference in composition, and the boundary between the layers 21 becomes less clear in the layers 21 that are away from the first surface 3. In FIG. 2, the denser the hatching of the layers 21 on the built-up portion 2 is, the more base material 4 components are contained therein and the closer the composition is to that of the base metal, and the more the lines of the boundaries between the layers 21 turn from thick solid lines to thin broken lines, the less clear the boundaries of the layers 21 become.

On the other hand, if a powder of a steel of the same composition as the steel of the base material 4 is used to form the built-up portion 2, the built-up portion 2 will be formed with a composition that same as that of the steel of the base material 4, and thus the composition between the layers 21 will be consistent in the boundaries between the layers 21 in the built-up portion 2. For this reason, compared to a case in which the built-up portion 2 is formed with a composition that is different to that of the steel of the base material 4, the boundaries between the layers 21 become unclear due to the difference in the composition thereof.

### Effect of Mold Component Manufacturing Method

The mold component manufacturing method to according the embodiment described above exhibits the following effects.

It is possible improve the state-of-wear of the mold component by forming a built-up portion on the removed region of the worn mold component to restore the mold component to the initial state thereof before being worn or near to the initial state thereof before being worn. For example, it is preferable that the thickness of the built-up portion is thicker than the thickness of the region removed from the worn mold component when the first surface is formed. In particular, it is also possible to restore the mold component to the initial state thereof before being worn. Thus, by recycling a worn mold component to the initial state thereof, or a state that is not the initial state thereof but is a state in which the mold component can be used, it is possible to reduce the cost and time needed to manufacture a mold compared to making a completely new mold component. Also, the first surface is formed at the removed region of the mold component and is made to be a flat surface in the preprocessing step before the building-up step, thus making it easy to form the built-up portion.

### Effect of Mold Component

The mold component according to the embodiment described above exhibits the following effects.

The built-up portion has a laminate structure in which a plurality of layers are laminated, and therefore it is easy to form the built-up portion with a uniform thickness.

### Test 1

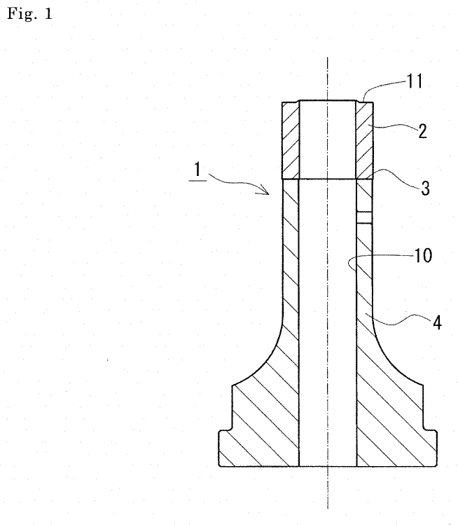

The mold component manufacturing method according to the above-described embodiment was implemented on a used punch, where the punch was recycled by forming a built-up portion on an end surface (first surface) of the punch, and the recycled punch was thus evaluated. The prepared punch was a lower punch of a powder metallurgy mold with a die, and is slidably fitted into a hole in the die. The material of the punch (the base material) was die steel (SKD11), which is a quenched and tempered steel. The material of the punch had a Vickers hardness of 579 HV (0.1). “HV (0.1)” is a standard based on JIS Z 2244:2009, and means measurement was performed using a load weight (test force) of 0.1 kgf (0.9807 N). As shown in FIG. 1, the punch is cylindrical and is formed with a through-hole 10 passing therethrough in the axial direction. A core rod (not shown) passes through the through-hole 10. The end portion of the leading end side (the top side of FIG. 1) of a punch 1 shown in FIG. 1 is fitted into the hole of the die, and the end surface of the punch 1 is a mold surface 11 which presses the raw material powder when the raw material powder is press-compacted. In this example, the mold surface 11 has an outer diameter of 23.96 mm, and an inner diameter of 14.99 mm.

In Test 1, as shown in FIG. 1, after the first surface 3 is formed by cutting the leading end member of the used punch 1 perpendicular to the axis thereof through wire cutting and removing the cut portion, surface grinding is performed on the first surface 3 of the base material 4 and the surface roughness (maximum height Rz) of the first surface 3 is thus 1 μm or less. Subsequently, SUS420J2 (quenched and tempered steel) is built up on the first surface 3 to form the built-up portion 2, thus restoring the punch 1 to the initial state thereof. Specifically, the punch 1 is cut perpendicular to the axis thereof at a position that is 20 mm in the axial direction from the mold surface 11 of the punch 1 in the initial state thereof, and the built-up portion 2 with a thickness of 20 mm is formed on the first surface 3, which is the cut surface onto which surface grinding was performed. Building-up was performed with use of a 3D metal printer (the OPM250L manufactured by Sodick Co., Ltd.), and the built-up portion 2 was laminate molded by forming a layer of SUS420J2 metal powder on the first surface 3 of the base material 4, irradiating and melting the layer of metal powder with a laser, and solidifying the layer of irradiated and melted metal powder. Here, SUS420J2 metal powder having an average particle size of 41 μm was used, and the laminate molding conditions were a laminate pitch of 0.05 mm and a total number of laminate layers of 400 layers (0.05 mm×400 layers=20 mm). “Average particle size” means the particle size that is 50% the accumulated volume in the particle size distribution measured by a laser diffraction-type particle-size-distribution measuring apparatus. In other words, the “average particle size” means the median diameter (D50). Also, after the built-up portion 2 is formed, finishing processing is performed on the built-up portion 2 after tempering, and thus the mold surface 11 is formed. The tempering was performed for one hour at 180° C.

The recycled punch was attached to a press, and raw material powder was press-compacted to form 100 ring shaped compacts. Here, as the raw material powder, pure iron powder (average particle size: 100 μm) with 1.5 mass percentage of copper powder and 0.6 mass percentage of graphite powder added thereto was used, with a compacting pressure of 588 MPa (6 t/cm²) and a green density of 6.7 g/cm³. All of the thus-formed compacts satisfied predetermined dimensional accuracy, and the shape of the end surface thereof was also favorable. Also, the punch was removed from the press after compacting was performed, and as the punch had been inspected for dimensional deformation before and after the compacting, no deformation or wear was found on the built-up portion, and thus the punch had adequately withstood use.

The Vickers hardness of the built-up portion of the punch was measured after the punch had been used in the compacting. Here, the Vickers hardness of the end surface of the built-up portion was measured at 3 points, and the average thereof was taken. As a result, the Vickers hardness of the built-up portion was 615 HV (OA).

### LIST OF REFERENCE NUMERALS

1 Punch
10 Through-hole
11 Mold surface
2 Built-up portion
3 First surface
4 Base material
100 Mold component
21 Layer
22 Laminate structure

1. A mold component manufacturing method, comprising:
a step of forming a first surface by removing a predetermined region that contains a worn location from a worn mold component; and
a step of building up a steel material on the first surface.

2. The mold component manufacturing method according to claim 1,
wherein a maximum height Rz of surface roughness of the first surface is less than or equal to 1 μm.

3. The mold component manufacturing method according to claim 1, wherein, in the building-up step, a built-up portion is formed by sequentially forming a layer of a powder of the steel material on the first surface and irradiating the powder with a laser.

4. The mold component manufacturing method according to claim 1,
wherein the Vickers hardness of the built-up portion formed through the building-up step is at least 90% as hard as the Vickers hardness of a base material of the mold component.

5. The mold component manufacturing method according to claim 1, wherein the steel material is a quenched and tempered steel and, after the building-up step, a step is provided in which the mold component that has been built up is tempered.

6. The mold component manufacturing method according to claim 1, wherein the mold component is a punch.

7. A mold component comprising:
a base material that includes a first surface; and
a built-up portion formed on the first surface of the base material,
wherein
the built-up portion has a laminate structure in which a plurality of layers formed from a steel material are stacked.
